(19) United States
(12) Patent Application Publication
(10) Pub. No.: US 2013/0325477 A1
(43) Pub. Date: Dec. 5, 2013

(54) SPEECH SYNTHESIS SYSTEM, SPEECH SYNTHESIS METHOD AND SPEECH SYNTHESIS PROGRAM

(71) Applicants: Yasuyuki Mitsui, Tokyo (JP); Reishi Kondo, Tokyo (JP); Masanori Kato, Tokyo (JP)

(72) Inventors: Yasuyuki Mitsui, Tokyo (JP); Reishi Kondo, Tokyo (JP); Masanori Kato, Tokyo (JP)

(73) Assignee: NEC Corporation, Tokyo (JP)

(21) Appl. No.: 14/000,110

(22) PCT Filed: Feb. 17, 2012
(86) PCT No.: PCT/JP2012/054484

§ 371 Date: Aug. 16, 2013

(30) Foreign Application Priority Data
Feb. 22, 2011 (JP) 2011-035542

(51) Int. Cl. G10L 13/04

(52) U.S. Cl. CPC G10L 13/04
USPC 704/258

(57) ABSTRACT

A speech synthesis system includes: a training database storing training data which is set of features extracted from speech waveform data; a feature space division unit which divides a feature space which is a space concerning to the training data into partial spaces; a sparse or dense state detection unit which detects a sparse or dense state to each partial space which is the divided feature space, generates sparse or dense information which is information indicating the sparse or dense state and outputs the sparse or dense information; and a pronunciation information correcting unit which corrects pronunciation information which is used for speech synthesis based on the outputted sparse or dense information.

### TECHNICAL FIELD

The present invention relates to a speech synthesis system, a speech synthesis method and a speech synthesis program and in particular, relates to technology which realizes a speech synthesis with high naturalness.

### BACKGROUND ART

In recent years, by the progress of text-to-speech synthesis technology (Text-to-Speech: TTS), service and a product using synthetic speech equipped with manhood have often been seen. TTS generally analyzes a linguistic structure or the like of text inputted by a morphological analysis or the like first (linguistic analysis processing) and generates phoneme information given an accent or the like based on the result. TTS presumes a fundamental frequency (F0) pattern and phoneme duration time length based on pronunciation information and generates prosody information (prosody generation processing). Finally, TTS generates a waveform based on the generated prosody information and the phoneme information (waveform generation processing).

As the prosody generation processing method mentioned above as indicated in a non-patent literature 1, a method is known that F0 pattern is modeled so as to be expressed by a simple rule and prosody is generated using the rule. Thus, although the method using the rule has been used widely because F0 pattern can be generated by a simple model, prosody gets unnatural and there is a problem that synthetic speech becomes mechanical.

In contrast, a speech synthesis method using a statistical method is noted in recent years. Its typical technique is described in a non-patent literature 2. The non-patent literature 2 discloses HMM-based speech synthesis using the hidden Markov model (hidden Markov model: HMM) as a statistical method. HMM-based speech synthesis technology generates speech using a prosody model and a speech synthesis unit (parameter) model with a great deal of training data. Because the HMM-based speech synthesis technology makes speech which an actual man has vocalized training data, the more human prosody can be generated compared with the F0 generation model mentioned above.

### CITATION LIST

### Non-Patent Literature

[Non-Patent Literature 1] Hiroya Fujisaki, Hiroshi Sudo, “A Model for the Generation of Fundamental Frequency Contours of Japanese Word Accent “, Acoustical Society of Japan magazine, Vol. 27, No. 9, pp. 445-453, 1971.

[Non-Patent Literature 2] Keiichi Tokuda, “SPEECH SYNTEHSIS BASED ON HIDDEN MARKOV MODELS”, Institute of Electronics, Information and Communications Engineers, Technical report, SP99-61, pp. 47-54, 1999.

### SUMMARY OF INVENTION

### Problems to be Solved by the Invention

However, in the speech synthesis method using the statistical method disclosed in the non-patent literatures mentioned above, right F0 pattern is not generated, and the speech may be unnatural. This is because, since the speech synthesis system using the statistical method divides a training data space into partial spaces (clustering) mainly based on information volume of the training data, a sparse or dense state of the information volume occurs in the space, and because a sparse partial space exists in which there is not much training data.

As one of methods to settle this problem, a method to perform model training with a great deal of data is considered. However, because it is difficult to collect the great deal of training data, and it is not clear how much volume of data to be collected is enough, thus it is not realistic.

It is an object of the present invention to provide the technology which makes speech synthesis with high naturalness possible without collecting a great deal of training data uselessly.

### Means for Solving the Problem

In order to achieve the object mentioned above, a speech synthesis system of the present invention includes: a training database storing training data which is set of features extracted from speech waveform data; a feature space division means for dividing a feature space which is a space concerning to the training data which the training database stores into partial spaces; a sparse or dense state detection means for detecting a sparse or dense state to each partial space which is the feature space divided by the feature space division means, generating sparse or dense information which is information indicating the sparse or dense state and outputting the sparse or dense information; and a pronunciation information correcting means for correcting pronunciation information which is used for speech synthesis based on the sparse or dense information outputted from the sparse or dense state detection means.

In order to achieve the object mentioned above, a speech synthesis method of the present invention includes storing training data which is set of features extracted from speech waveform data; dividing a feature space which is a space concerning to the stored training data into partial spaces; detecting a sparse or dense state to each partial space which is the divided feature space, generating sparse or dense information which is information indicating the sparse or dense state, and outputting the sparse or dense information; and correcting pronunciation information which is used for speech synthesis based on the outputted sparse or dense information.

In order to achieve the object mentioned above, a program which a recording medium of the present invention stores, makes, a computer execute processing for: storing training data which is set of features extracted from speech waveform data; dividing a feature space which is a space concerning to the stored training data into partial spaces; detecting a sparse or dense state to each partial space which is the divided feature space, generating sparse or dense information which is information indicating the sparse or dense state, and outputting the sparse or dense information; and correcting pronunciation information which is used for speech synthesis based on the outputted sparse or dense information.

### Advantageous Effect of the Invention

According to a speech synthesis system, a speech synthesis method and a speech synthesis program of the present invention, speech synthesis with high naturalness can be made possible without collecting a great deal of training data uselessly.

### BRIEF DESCRIPTION OF THE DRAWINGS

FIG. 1 is a block diagram which shows an exemplary configuration of a speech synthesis system 1000 according to a first exemplary embodiment of the present invention.

FIG. 2 is a flowchart which shows an operation example of the speech synthesis system 1000 according to the first exemplary embodiment of the present invention.

FIG. 3 is a block diagram which shows an exemplary configuration of a speech synthesis system 2000 according to a second exemplary embodiment of the present invention.

FIG. 4 is a schematic diagram of a decision tree generated by binary tree clustering as a result trained in a feature space division unit 1.

FIG. 5 is a notional schematic diagram of a feature space representing a clustering result of training data by the feature space division unit 1.

FIG. 6 is a flowchart which shows an operation example in a preparatory step that generates a prosody generation model in the speech synthesis system 2000.

FIG. 7 is a flowchart which shows an operation example of a speech synthesis step that performs speech synthesis processing actually in the speech synthesis system 2000.

FIG. 8 is a block diagram which shows an exemplary configuration of a speech synthesis system 3000 according to a third exemplary embodiment of the present invention.

FIG. 9 is a flowchart which shows an operation example of a preparatory step that generates a prosody generation model and a waveform generation model in the speech synthesis system 3000.

FIG. 10 is a flowchart which shows an operation example of a speech synthesis step that performs speech synthesis processing actually in the speech synthesis system 3000.

FIG. 11 is a block diagram which shows an example of a hardware configuration which realizes the speech synthesis system 2000 according to the second exemplary embodiment.

### DESCRIPTION OF EMBODIMENTS

First, in order to understand exemplary embodiments of the present invention easily, a background of the present invention will be described.

In technology using the statistical method disclosed in the non-patent literature 2, right F0 pattern is not generated, and the speech may be unnatural.

When described specifically, for example, a sufficient number of training data with a degree of several moras exists such as “HITO” (two moras), “TANGO” (three moras) and “ONSEI” (four moras). Here, a mora is a syllable of sound with fixed temporal length and is also generally called “HAKU” in Japanese. Therefore, the technology using the statistical method can generate right F0 pattern in terms with the sound of the degree of several moras. However, for example, training data such as “Albert Einstein IKA DAIGAKU”(eighteen moras in Japanese) has the possibility to become extremely small in number or not to exist. Therefore, when a text including such word is inputted, F0 pattern is disordered, and a problem that accent position shifts occurs.

According to exemplary embodiments of the present invention described below, pronunciation information belonging to a sparse partial space is corrected. Therefore, according to the exemplary embodiments of the present invention, the instability of the speech synthesis caused by a lack of the training data can be avoided, and synthetic speech with high naturalness becomes enabled to be generated.

Hereinafter, the exemplary embodiments of the present invention will be described with reference to drawings. Further, the same reference sign is attached to a similar component concerning to each exemplary embodiment, and the description is omitted appropriately. Although each following exemplary embodiment is described using an example in the case of Japanese, the application of the present invention is not limited to case of Japanese.

### First Sxemplary Embodiment

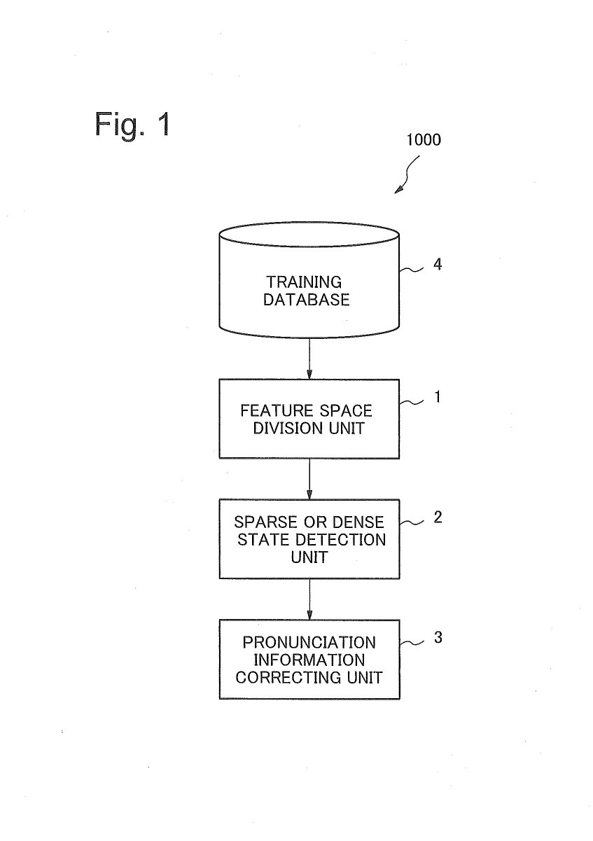

FIG. 1 is a block diagram which shows an exemplary configuration of a speech synthesis system 1000 according to a first exemplary embodiment of the present invention. Referring to FIG. 1, the speech synthesis system 1000 according to this exemplary embodiment includes a feature space division unit 1, a sparse or dense state detection unit 2, a pronunciation information correcting unit 3 and a training database 4.

The training database 4 stores set of features extracted from speech waveform data as training data. The training database 4 stores pronunciation information which is a character string corresponding to the speech waveform data. The training database 4 may store time length information and pitch information or the like.

Here, the feature that is the training data includes F0 pattern at least that is time change information of F0 in speech waveform. And the feature that is the training data may include spectrum information obtained by the Fast Fourier Transform (FFT) of speech waveform and segmentation information which is time length information for each phoneme or the like.

The feature space division unit 1 divides space (hereinafter, referred to as “feature space”) concerning to the training data which the training database 4 stores into the partial spaces. The feature space is the N dimension space which includes N pieces of the predetermined feature as its axis, here. The dimensional several N is optional and when two features of the spectrum information and the segmentation information, for example, are used as the axis, the feature space is two-dimensional space.

The feature space division unit 1 may divide the feature space into the partial spaces by binary tree clustering or the like based on the amount of information. The feature space division unit 1 outputs the training data divided into the partial spaces to the sparse or dense state detection unit 2.

The sparse or dense state detection unit 2 detects a sparse or dense state to each partial space generated in the feature space division unit 1 and generates sparse or dense information which is information indicating the sparse or dense state. The sparse or dense state detection unit 2 outputs the sparse or dense information which has generated to the pronunciation information correcting unit 3.

Here, the sparse or dense information is information which indicates a sparse or dense state of the amount of information of the training data. The sparse or dense information may be also the mean value and the variance of a feature vector of group of the training data belonging to the partial space.

The pronunciation information correcting unit 3 corrects pronunciation information used for the speech synthesis based on the sparse or dense information outputted from the sparse or dense state detection unit 2.

Here, the pronunciation information is required information in order to synthesize speech and may include information such as a phoneme, a syllable train and an accent position which express the speech contents.

The pronunciation information correcting unit 3 corrects pronunciation information which will be expressed by the feature belonging to a (sparse) partial space with few training data to pronunciation information which is expressed by the feature belonging to a (dense) partial space with a lot of training data.

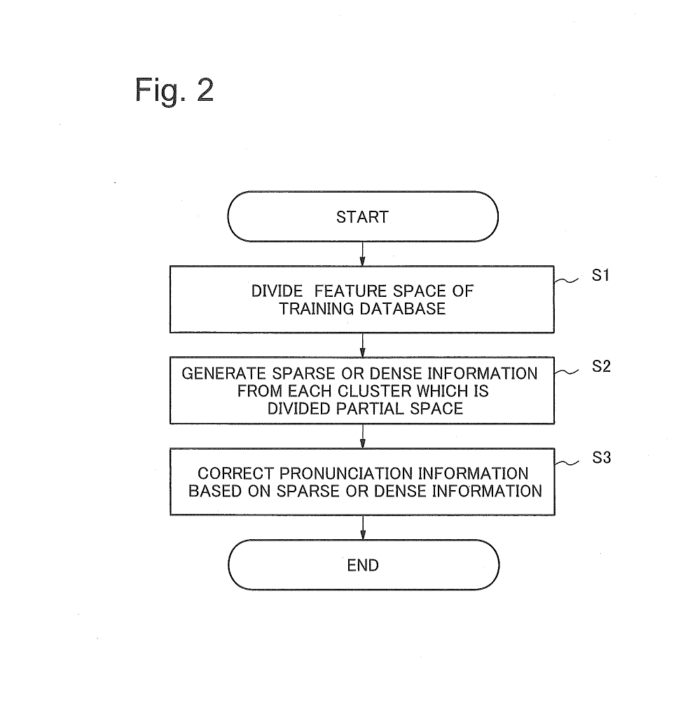

FIG. 2 is a flowchart which shows an operation example of the speech synthesis system 1000 according to the first exemplary embodiment of the present invention.

As shown in FIG. 2, first, the feature space division unit 1 divides the feature space which is a space concerning to the training data which the training database 4 stores (Step S1).

Next, the sparse or dense state detection unit 2 detects a sparse or dense state of the amount of information of the training data in each partial space which is a part of the feature space divided by the feature space division unit 1 and generates sparse or dense information which is information indicating the sparse or dense state (Step S2). The sparse or dense state detection unit 2 outputs the sparse or dense information which has generated to the pronunciation information correcting unit 3.

Next, the pronunciation information correcting unit 3 corrects pronunciation information used for speech synthesis based on the sparse or dense information outputted from the sparse or dense state detection unit 2 (Step S3).

In this way, according to the speech synthesis system 1000 of this exemplary embodiment like the above, the instability of the speech synthesis which is caused by a lack of the training data can be avoided, and synthetic speech with high naturalness can be generated. The reason is because the speech synthesis system 1000 corrects the pronunciation information belonging to a sparse partial space.

### Second Exemplary Embodiment

Next, a second exemplary embodiment of the present invention will be described.

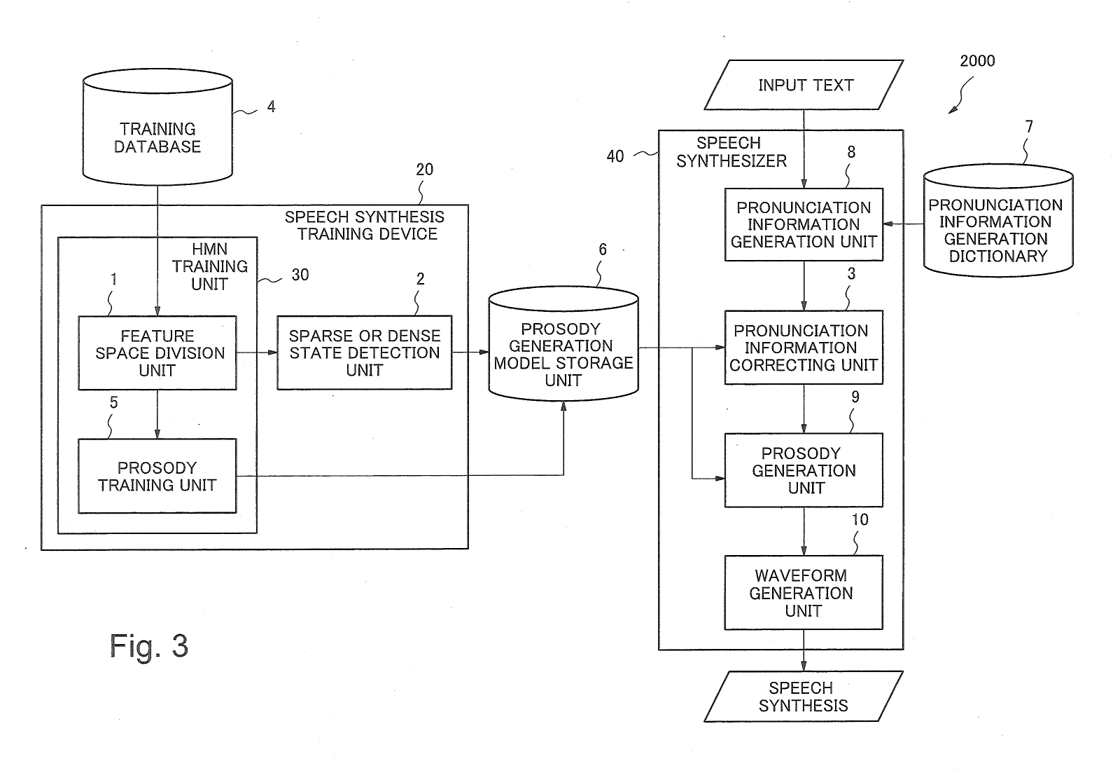

FIG. 3 is a block diagram which shows a configuration example of a speech synthesis system 2000 according to the second exemplary embodiment of the present invention. Referring to FIG. 3, the speech synthesis system 2000 according to this exemplary embodiment includes a training database 4, a speech synthesis training device 20, a prosody generation model storage unit 6, a pronunciation information generation dictionary 7 and a speech synthesizer 40.

The speech synthesis training device 20 includes a feature space division unit 1, a sparse or dense state detection unit 2 and a prosody training unit 5. The feature space division unit 1 and the sparse or dense state detection unit 2 have the same configurations as those in the first exemplary embodiment.

Further, according to this exemplary embodiment, it is supposed that HMM is employed as a statistical method and the binary tree clustering is employed as a partition method of a feature space. The case that the HMM is employed as the statistical method is the case that clustering and training are performed alternately is general. Therefore, in this exemplary embodiment, it is supposed that a HMM training unit 30 is composed with the combination of the feature space division unit 1 and the prosody training unit 5 and does not employ the explicitly divided configuration. However, this exemplary embodiment is just an example of the embodiment of invention, and the composition of the invention besides HMM is not limited to this, such as in the case of using a statistical method.

Referring to FIG. 3, the speech synthesizer 40 includes a pronunciation information correcting unit 3, a pronunciation information generation unit 8, a prosody generation unit 9 and a waveform generation unit 10. The pronunciation information correcting unit 3 is the same configuration as the first exemplary embodiment.

In this exemplary embodiment, it is supposed that sufficient training data is stored in the training database 4 in advance. That is, the training database 4 stores feature extracted from a plenty of speech waveform data. It is supposed that the training database 4 stores a F0 pattern, segmentation information and spectrum information as the feature of the speech waveform data. And set of these features is employed as the training data. The training data is supposed to be the collected speech of one speaker.

A speech synthesis method according to this exemplary embodiment is mainly separated into two steps of a preparatory step that the speech synthesis training device 20 generates a prosody generation model by HMM training and a speech synthesis step that the speech synthesizer 40 performs speech synthesis processing actually. The respective one will be described in turn.

First, in the HMM training unit 30 (the feature space division unit 1 and the prosody training unit 5), training is performed by a statistical method using the training database 4.

The feature space division unit 1 of the HMM training unit 30 divides a feature space which is a space concerning to the training data which the training database 4 stores into partial spaces as same as the first exemplary embodiment. Specifically, the feature space division unit 1 divides the feature space which the training database 4 stores into the partial spaces by the binary tree clustering. In below, it is also called a cluster concerning to the partial space generated by the feature space division unit 1.

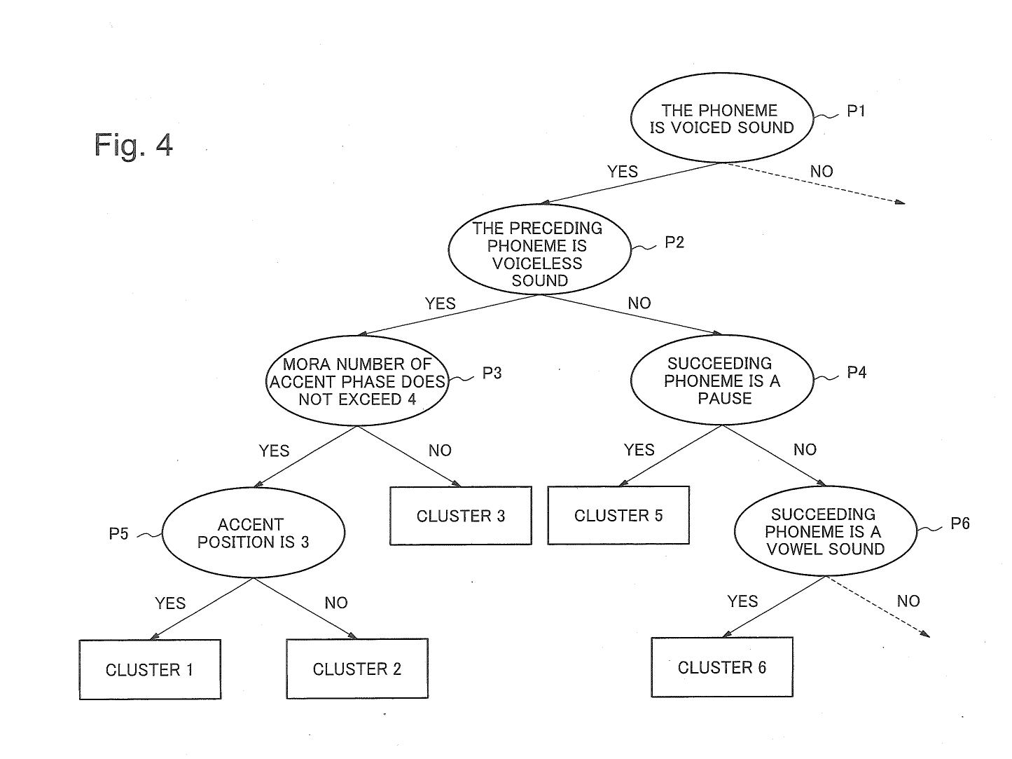

FIG. 4 is a schematic diagram of decision tree generated by the binary tree clustering as a result trained in the feature space division unit 1. As shown in FIG. 4, the binary tree clustering is a method of repeating the processing to divide the training data into two nodes by the question arranged in each node of P1-P6 and clustering for amount of information of each cluster divided so as to become equal finally.

In FIG. 4, for example, the feature space division unit 1 divides the training data by judging whether it belongs to “YES” or “NO” based on a question arranged in the present node. In an example in FIG. 4, the feature space division unit 1 divides the training data by judging whether “the phoneme is voiced sound” or not based on the question arranged initially in the node P1. Next, for example, the feature space division unit 1 divides the training data, which is divided by the judgment of “YES”, based on the judging whether “the preceding phoneme is voiceless sound” or not, which is the question arranged in the node P2. The feature space division unit 1 repeats such division and makes the divided training data one cluster at the time divided into the predetermined number of training data.

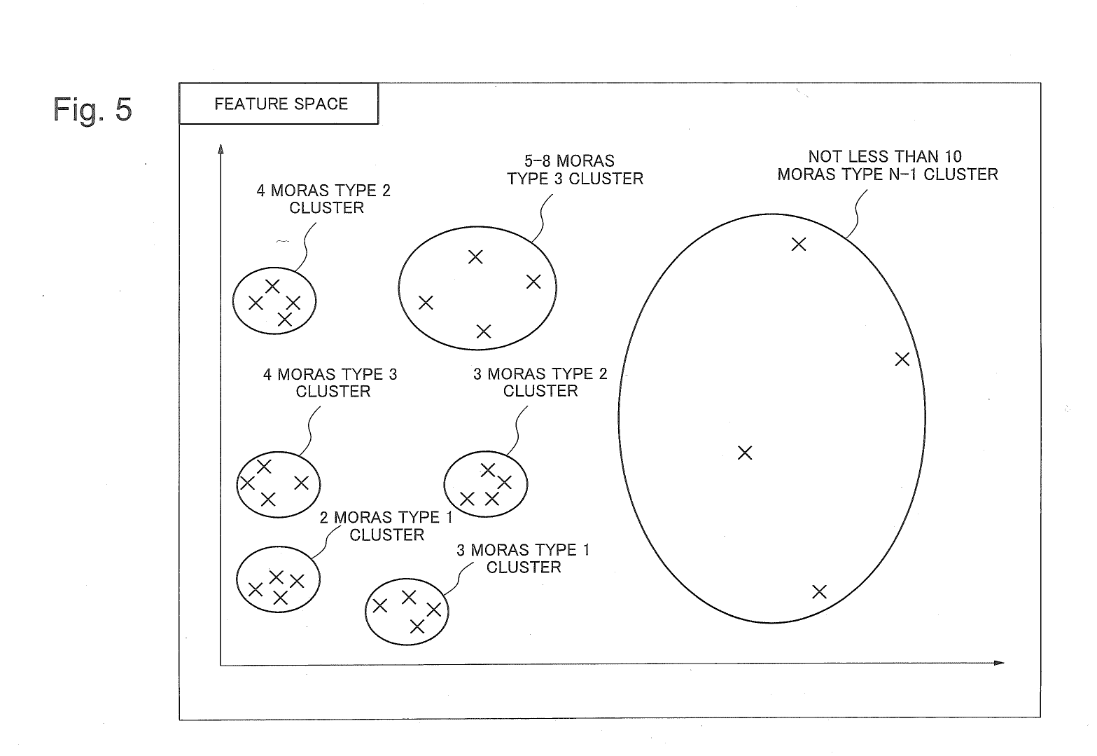

FIG. 5 is a notional schematic diagram of the feature space representing the clustering result of the training data by the feature space division unit 1. A vertical axis and a horizontal axis in FIG. 5 indicate the predetermined feature.

In FIG. 5, the case is indicated that the number of training data belonging to each cluster is four. In FIG. 5, it is indicated what happens to the number of moras of the training data which comes under each cluster and the style of the accent nucleus as the result of dividing the training data into 4 by the feature space division unit 1. Here, the style of the accent nucleus is the type that indicates the position just before the tone interval falls greatly in one accent phrase.

Note, FIG. 5 is a schematic diagram which has indicated the concept to the end, and the number of axes is not limited to 2. For example, the feature space may be a 10 dimension space whose axes are set by ten features.

As shown in FIG. 5, the feature space division unit 1 generates a large cluster in the space where the number of the training data is sparse such as the cluster with more than type 8 and more than 10 moras. Such cluster will be a sparse cluster with very few training data.

The feature space division unit 1 outputs the training data divided into the partial space to the sparse or dense state detection unit 2 and the prosody training unit 5.

The HMM training unit 30 generates a prosody generation model as well as division of the feature space.

The prosody training unit 5 of the HMM training unit 30 trains a prosody model in the space of the feature divided by the feature space division unit 1 and generates the prosody generation model. That is, the prosody training unit 5 generates the prosody generation model using the clustering result (as a result of the binary tree clustering shown in FIG. 4, for example) of the training data in the feature space division unit 1.

Specifically, the prosody training unit 5 statistically trains what kind of prosody to generate to the pronunciation information corresponding to the speech waveform data which the training database 4 stores for each cluster. The prosody training unit 5 handles the result of the training as a model (prosody generation model), and stores it in the prosody generation model storage unit 6 corresponding to each cluster.

Note, the training database 4 may have the configuration in which time length information and pitch information are not stored and the prosody training unit 5 may have the configuration which the time length information and the pitch information corresponding to the pronunciation information from the inputted speech waveform data are trained.

Next, the sparse or dense state detection unit 2 detects a sparse or dense state of each cluster in the training data inputted from the feature space division unit 1 and extracts sparse or dense information which indicates the sparse or dense state. For example, the sparse or dense information may be also the number of moras of the accent phrase and variance concerning to the relative position of the accent nucleus. At that time, for example, all data belong to 3 moras type 1 in the 3 moras type 1 cluster shown in FIG. 5. Therefore, the variance will be 0.

The sparse or dense state detection unit 2 stores the extracted sparse or dense information of each cluster in the prosody generation model storage unit 6 with the shape corresponded to the prosody generation model. Otherwise, the sparse or dense state detection unit 2 may store the sparse or dense information in a database which is not illustrated together with a correspondence table which maps the prosody generation model and the sparse or dense information of each cluster.

The prosody generation model storage unit 6 stores the prosody generation model generated by the prosody training unit 5. The prosody generation model storage unit 6 may include the sparse or dense information extracted by the sparse or dense state detection unit 2 in the prosody generation model and store it. In this exemplary embodiment, it is supposed that the sparse or dense information is included in the prosody generation model.

The above is the preparatory step that the prosody generation model is generated by the speech synthesis training unit 20. Next, the processing of the speech synthesis step will be described.

When a text is inputted which is an object of speech synthesis, the pronunciation information generation unit 8 generates pronunciation information using the pronunciation information generation dictionary 7.

Specifically, the pronunciation information generation unit 8 performs linguistic analysis by morphological analysis or the like to the inputted text. The pronunciation information generation unit 8 generates the pronounce information by performing the processing of adding or changing additional information to the linguistic analysis for speech synthesis such as an accent position and an accent phrase boundary.

The pronunciation information generation dictionary 7 stores linguistic analysis information which is information concerning to data and rules needed to the linguistic analysis processing of text. The linguistic analysis information is information concerning to the data and rules for the morphological analysis, for example.

The pronunciation information generation dictionary 7 includes information which indicates an additional method of the additional information for the speech synthesis which is the information on the accent position and the accent phrase boundary position in addition to the linguistic analysis information. The pronunciation information generation dictionary 7 may store score for generating the pronunciation information.

For example, the case is considered that the text including the word of “Albert Einstein IKA DAIGAKU” has been inputted to the pronunciation information generation unit 8. In this case, the pronunciation information generation unit 8 may output a character string as “a ru ba- to a i N syu ta i N i ka da @ i ga ku” with Japanese reading as the pronunciation information. Further, “@” indicates an accent position.

The pronunciation information generation unit 8 may perform score calculation for respective pronunciation information using the score that the pronunciation information generation dictionary 7 stores and generate a plurality of candidates of the pronunciation information up to the N-th rank in higher score order. Specifically, when the pronunciation information of “Albert Einstein IKA DAIGAKU” is generated, the pronunciation information generation unit 8 generates a character string of “a ru ba- to a i N syu ta i N i ka da @ i ga ku” as the first rank candidate of the pronunciation information. The pronunciation information generation unit 8 may generate the candidates of the pronunciation information up to the third rank, such as “a ru ba- to a i N syu ta @ i N | i ka da @ i ga ku” as the second rank and “a ru ba- @ to | aiN syu ta @ i N | i ka da @ i ga ku” as the third rank. Note, “|” means an accent phrase boundary.

The pronunciation information generation unit 8 outputs the generated pronunciation information to the pronunciation information correcting unit 3.

Next, the pronunciation information correcting unit 3 corrects the pronunciation information based on the sparse or dense information of each cluster which the prosody generation model storage unit 6 stores. It is supposed that the pronunciation information correcting unit 3 corrects the pronunciation information by the policy that “When an accent phrase belonging to a sparse cluster is included in the pronunciation information, the pronunciation information which includes only an accent phrase belonging to a dense cluster is selected.”

Specifically, a threshold value of the variance is set, and the accent phrase belonging to a cluster in which the variance is no smaller than the threshold value is made the object of correction. For example, when it is assumed that the variance of 6-8 moras type 3 cluster is σA and the variance of the cluster which is more than 10 moras and more than type 8 is σB, the pronunciation information correcting unit 3 sets the threshold value σT of the variance that meets σA<σT<σB.

In this case, because the variance of the 3 moras type 1 cluster is 0, the pronunciation information correcting unit 3 does not correct concerning to the accent phrase of 3 moras type 1 such as “BOKUWA” and “MAKURA”. Similarly, the pronunciation information correcting unit 3 does not also correct concerning to an accent phrase belonging to 6-8 moras type 3 cluster such as “KAKUKAIHATSU (six moras)” because of σT>σA.

On the other hand, concerning to an accent phrase belonging to a cluster which is more than 10 moras more than type 8 such as “Albert Einstein IKA DAIGAKU (18 moras type 15)”, the pronunciation information correcting unit 3 corrects the pronunciation information so that the accent phrase belonging to the cluster whose variance is no smaller than the threshold value may not be included. The pronunciation information correcting unit 3 may correct the pronunciation information by selecting other pronunciation information which the pronunciation information generation unit 8 has generated or may correct the pronunciation information by dividing the pronunciation information with reference to the pronunciation information generation dictionary 7 and replacing the accent phrase.

Hereinafter, a method to correct the pronunciation information by selecting other pronunciation information will be described specifically. When pronunciation information on a word as “Albert Einstein IKA DAIGAKU” is generated, the pronunciation information generation unit 8 outputs a candidate of the pronunciation information up to the N-th rank in higher score order to the pronunciation information correcting unit 3.

Here, it is supposed that a candidate of the pronunciation information up to the third rank is inputted to the pronunciation information correcting unit 3. As described above, it is assumed that there are the pronunciation information such as “a ru ba- to a i N syu ta i N i ka da @ i ga ku” in the first rank, “a ru ba- to a i N syu ta @i N | i ka da @ i ga ku” in the second rank and “a ru ba- @ to | a i N syu ta @iN | i ka da @ i ga ku” in the third rank as the candidates.

In this case, the first rank is 18 moras type 15, and σT<σB Therefore, the pronunciation information correcting unit 3 excludes the first rank from the candidates.

Although the second rank is 12 moras type 10 and 6 moras type 3, a latter accent phrase is σT>σA, and a former accent phrase is σT<σB. Therefore, the pronunciation information correcting unit 3 excludes the second rank from the candidates.

Next, the third rank is constructed with 5 moras type 4, 7 moras type 5 and 6 moras type 3, and all of the variances are no more than the threshold value. Therefore, the pronunciation information correcting unit 3 selects this candidate.

As a result, the pronunciation information correcting unit 3 outputs the character string of “a ru ba- @ to | a i N syu ta @ i N | i ka da @ i ga ku” to the prosody generation unit 9 as the corrected pronunciation information.

Further, in the description mentioned above of this exemplary embodiment, the pronunciation information generation unit 8 generates a plurality of candidates of the pronunciation information. And when the candidate of the pronunciation information in the first rank includes the accent phrase belonging to a sparse cluster, the pronunciation information correcting unit 3 corrects the pronunciation information by selecting the candidate of the other pronunciation information which does not includes the accent phrases belonging to the sparse cluster.

As other configurations, the pronunciation information generation unit 8 may generate only the pronunciation information in the first rank. In the case, when correction is required to the pronunciation information, the pronunciation information correcting unit 3 may refer to the pronunciation information generation dictionary 7, and may correct by substituting the accent phrase so that the pronunciation information may include only an accent phrase belonging to a dense cluster.

In the case, when “a ru ba- to a i N syu ta i N i ka da @ i ga ku” which is the pronunciation information belongs to a sparse cluster, the pronunciation information generation unit 8 refers to the pronunciation information generation dictionary 7. The pronunciation information generation unit 8 divides the pronunciation information mentioned above into “a ru ba- to a i N syu ta @ i N | i ka da @ i ga ku” using the pronunciation information generation dictionary 7 and substitutes the pronunciation information with divided it. When it is judged that the correction is still required, the pronunciation information correcting unit 8 corrects the pronunciation information mentioned above in “a ru ba- @ to | a i N syu ta @ i N | i ka da @ i ga ku” and substitutes.

The prosody generation unit 9 generates prosody information using the prosody generation model which the prosody generation model storage unit 6 stores to the pronunciation information corrected by the pronunciation information correcting unit 3. The prosody generation unit 9 outputs the pronunciation information and the generated prosody information to the waveform generating unit 10.

The waveform generating unit 10 generates the speech waveform based on the pronunciation information and the prosody information which the prosody generation unit 9 has generated. The waveform generation may be performed based on a related technology, and the waveform may be generated by any kind of method. The waveform generating unit 10 outputs the generated speech waveform as synthetic speech.

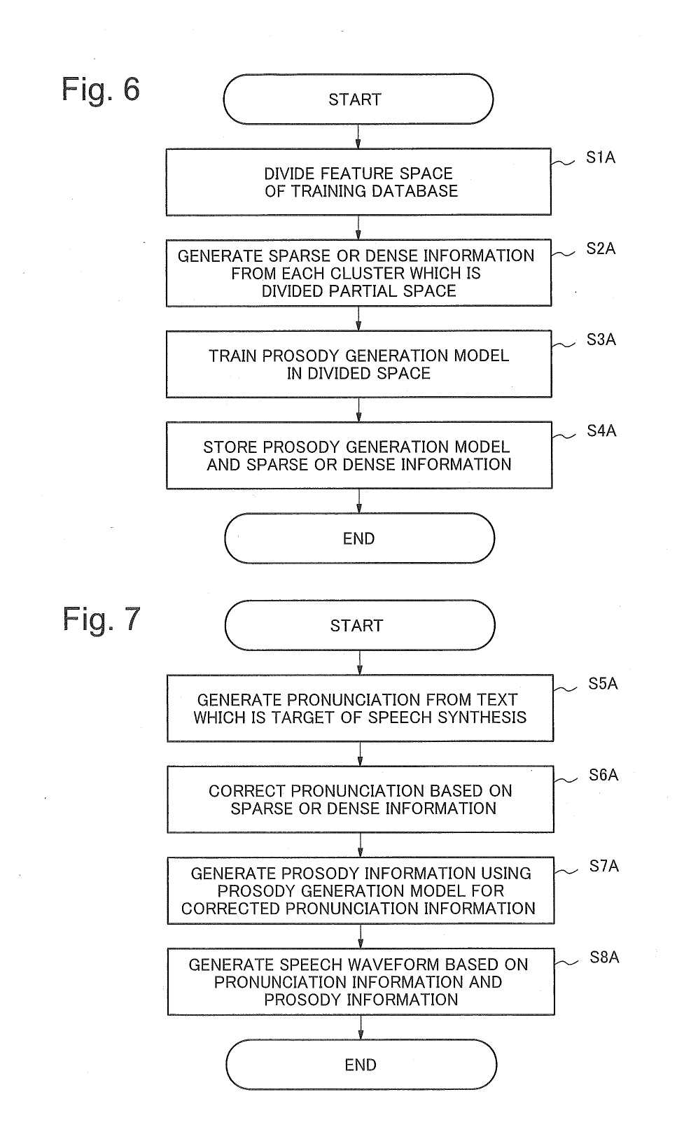

Next, with reference to FIG. 6 and FIG. 7, an operation flow of the speech synthesis system 2000 is described in turn by dividing into two steps of a preparatory step that generates a prosody generation model and a speech synthesis step that performs speech synthesis processing actually.

FIG. 6 is a flowchart which shows an operation example of the preparatory step that generates the prosody generation model in the speech synthesis system 2000.

As shown in FIG. 6, first, the feature space division unit 1 divides a feature space concerning to the training data which the training database 4 stores into partial spaces (Step S1A).

Next, the sparse or dense state detection unit 2 detects the sparse or dense state of each cluster that is the partial space generated by the feature space division unit 1, and generates sparse or dense information which indicates the sparse or dense state (Step S2A). The sparse or dense state detection unit 2 outputs the sparse or dense information which has generated.

Next, the prosody training unit 5 trains a prosody model in the space of the training data divided by the feature space division unit 1 and generates a prosody generation model (Step S3A). Further, Step S2A and Step S3A may be performed in reverse order and it may be performed in parallel.

Next, the prosody generation model storage unit 6 stores the prosody generation model generated by the prosody training unit 5 and the sparse or dense information outputted from the sparse or dense state detection unit 2 (Step S4A).

FIG. 7 is a flowchart which shows an operation example of the speech synthesis step that performs the speech synthesis processing actually in the speech synthesis system 2000.

As shown in FIG. 7, first, when a text which is an object of speech synthesis is inputted, the pronunciation information generation unit 8 generates pronunciation information using the pronunciation information generation dictionary 7 (Step S5A).

Next, the pronunciation information correcting unit 3 corrects the pronunciation information based on the sparse or dense information of each cluster which the prosody generation model storage unit 6 stores (Step S6A).

Next, the prosody generation unit 9 generates prosody information using the prosody generation model which the prosody generation model storage unit 6 stores to the pronunciation information corrected by the pronunciation information correcting unit 3 (Step S7A).

Next, the waveform generating unit 10 generates the speech waveform based on the pronunciation information and the prosody information which the prosody generation unit 9 has generated (Step S8A).

In this way, according to the speech synthesis system 2000 of this exemplary embodiment, the, disturbance of the F0 pattern that is caused by a lack of the training data can be avoided, and speech synthesis with high naturalness can be performed. The reason is because extraction of prosody training and the sparse or dense information is carried out based on the same clustering result, the pronunciation information with small volume of the training data is corrected to the pronunciation information with the sufficient training data, by correcting the pronunciation information based on the sparse or dense information with the pronunciation information correcting unit 3.

According to this exemplary embodiment, although the collected speech data from one speaker is assumed as the training database, the collected speech data from a plurality of speakers may be used as the training database. In case of the training database of single independent speaker, there is an effect that synthetic speech can be generated which has reproduced nature of the speaker such as habits of the speaker. In case of the training database of a plurality of speakers, there is an effect that general-purpose synthetic speech can be generated.

The speech synthesizer 40 may be made with a configuration which generates the candidates of the pronunciation information up to the N-th rank in the whole input text, and it may be made with a configuration which generates the candidates of the pronunciation information up to the N-th rank at each accent phrase boundary. When generating at each accent phrase boundary, the speech synthesizer 40 may generate the final pronunciation information by a route search method or the like using a score calculation after generating only the pronunciation information in the first rank, and generating the candidates of each accent phrase boundary of the pronunciation information up to the N-th rank.

### Third Exemplary Embodiment

Next, a third exemplary embodiment of the present invention will be described.

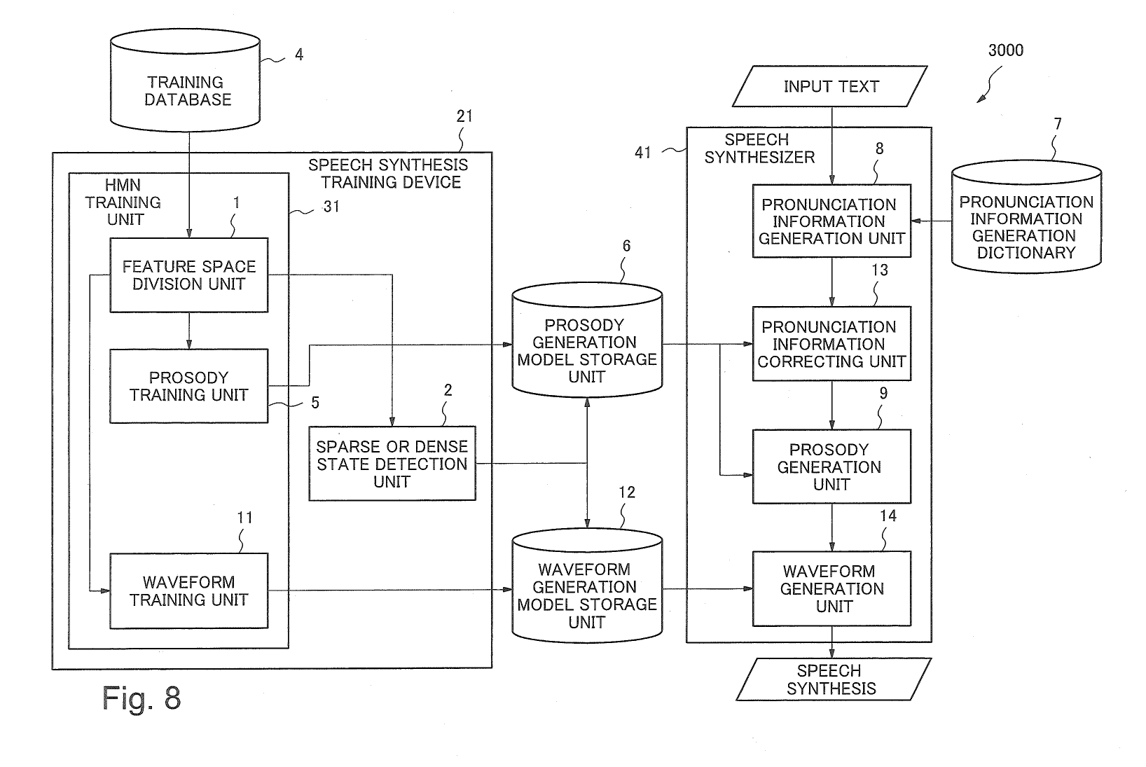

FIG. 8 is a block diagram which shows an exemplary configuration of a speech synthesis system 3000 according to the third exemplary embodiment of the present invention.

Referring to FIG. 8, the speech synthesis system 3000 according to the third exemplary embodiment includes a speech synthesis training device 21 and a speech synthesizer 41 instead of the speech synthesis training device 20 and the speech synthesizer 40 according to the second exemplary embodiment and further includes a waveform generation model storage unit 12.

The speech synthesis training device 21 includes a HMM training unit 31 that generates a prosody generation model and a waveform generation model using the training database 4, instead of the HMM training unit 30. The HMM training unit 31 further includes a waveform training unit 11 in addition to the same configuration as the HMM training unit 30.

The speech synthesizer 41 includes a pronunciation information correcting unit 13 which corrects additional information, instead of the pronunciation information correcting unit 3. And, the speech synthesizer 41 includes a waveform generating unit 14 which generates a waveform using the waveform generation model storage unit 12, instead of the waveform generating unit 10.

The waveform training unit 11 trains a waveform model in the space of the feature divided by the feature space division unit 1 and generates a waveform generation model.

The waveform generation model is what models a spectrum feature of waveform in the training database. Specifically, the feature may be a cepstrum or the like. Further, the model which is generated by the HMM is employed as the data for waveform generation in this exemplary embodiment. However, the speech synthesis method applied to the present invention is not limited to this, and the other speech synthesis method such as a waveform connection method, for example, may be used. Note, in the case, only the prosody generation model is trained in the HMM training unit 31.

The waveform generation model storage unit 12 stores the waveform generation model generated by the waveform training unit 11.

The pronunciation information correcting unit 13 corrects the additional information besides an accent position and an accent phrase boundary in pronunciation information. As a specific example, the operation is described that the pronunciation information correcting unit 13 corrects the additional information concerning to “Pause insertion/elimination” and “Change in expression”.

The correction of the additional information concerning to “Pause insertion/elimination” is a correction such as “To insert a pause in natural position” or “To delete the pause in unnatural position” so that the sound will be something to seem to be human. The correction contents in detail are “One breath phrase is not larger than N moras”, “A pause is put in after a conjunction” or the like, for example.

The correction of the additional information concerning to “Change in expression” will be to change a linguistic analysis result generated from an average text as a language to the expression peculiar to speaker. For example, a word of “HOSO” is usually attached reading of “ho- so-”. However, some speakers may read this as “housou” clearly. The correction contents representing this will be the contents that “A long sound is read as a vowel.”

The correction of the pronunciation information is performed by the same policy as the second exemplary embodiment. Specifically, the pronunciation information generation unit 8 generates a plurality of candidates of the pronunciation information. The pronunciation information correcting unit 13 excludes the candidates of the pronunciation information which the cluster whose variance is not smaller than the threshold value belongs to, and employs the candidates which are expressed only by the cluster whose variance is not larger than the threshold value. Of course, as mentioned above, after the speech synthesizer 41 may perform the score calculation and generate the final pronunciation information by a method to search for a route which takes the best score after obtaining the candidates of each accent phrase boundary up to the N-th rank.

As a specific example, the case that a text of “SOSHITE, HOSO GA KAISHI SARETA” has been inputted will be described. Here, it is assumed that the pronunciation information generation unit 8 generates candidates of the pronunciation information as “so shi te | PAU | ho- so- ga | ka i shi sa re ta” in the first rank, “so shi te | ho- so- ga | ka i shi sa re ta” in the second rank and “so shi te | hou sou ga | ka i shi sa re ta” in the third rank. Note, “PAU” means a pause.

It is supposed that the speech waveform data of a speaker who has the characteristic of speaking without pauses on the way and pronouncing the word of “HOSO” with “housou”, not “ho- so-” is stored in the training database 4. In this case, when the feature space which is training data is divided, it is assumed that the cluster of “pause after “SOSHITE”,” and the cluster of “continuation of the long sound vowel” rarely exits or do not exist as a cluster.

In this case, the variance will exceed the threshold value in the first candidate and the second candidate. Therefore, the pronunciation information correcting unit 13 corrects the pronunciation information by employing the third candidate.

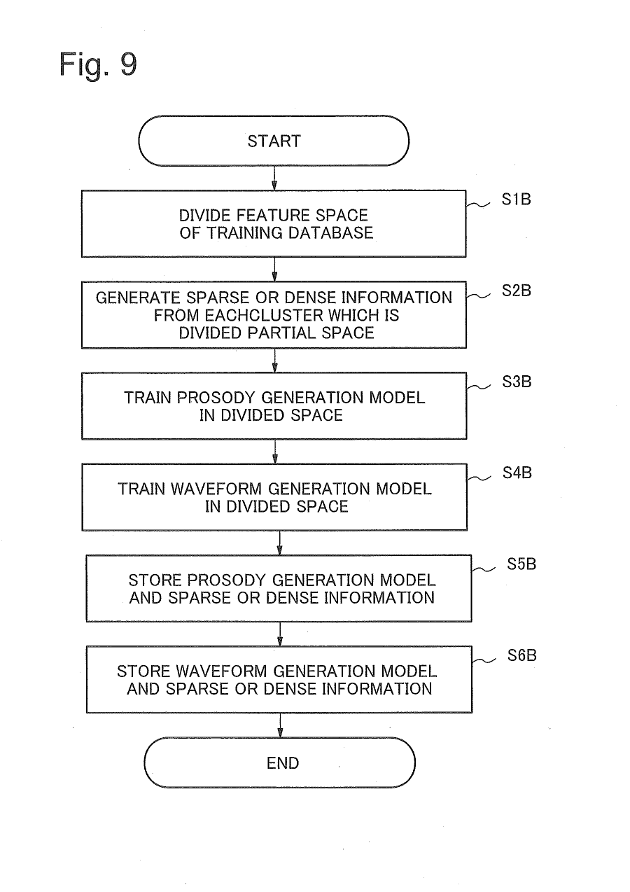

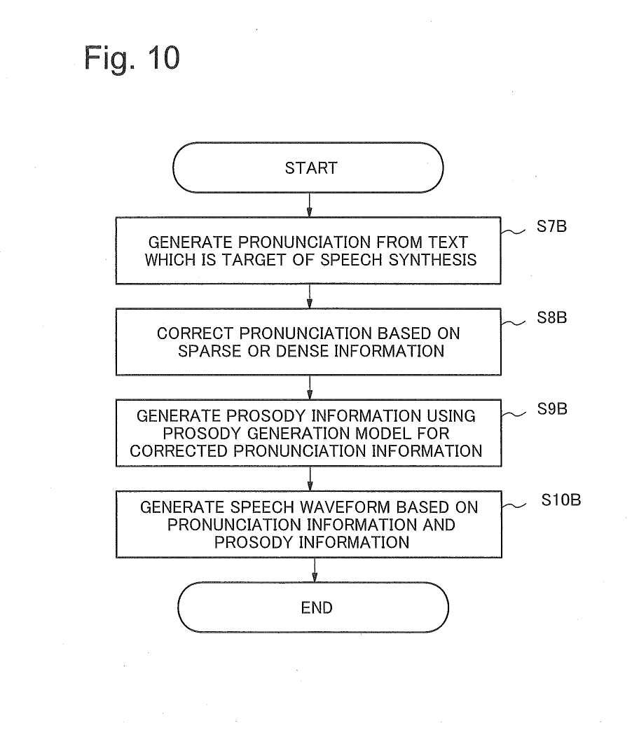

Next, an operation flow of the speech synthesis system 3000 is described in turn by dividing into two steps of a preparatory step that generates a prosody generation model and a waveform generation model, and a speech synthesis step that performs speech synthesis processing actually with reference to FIG. 9 and FIG. 10.

FIG. 9 is a flowchart which shows an operation example of the preparatory step that generates the prosody generation model and the waveform generation model in the speech synthesis system 3000.

As shown in FIG. 9, first, the feature space division unit 1 divides a feature space which the training database 4 stores into the partial spaces (Step S1B).

Next, the sparse or dense state detection unit 2 detects the sparse or dense state of each cluster which is the partial space generated by the feature space division unit 1, and generates sparse or dense information which indicates the sparse or dense state (Step S2B).

Next, the prosody training unit 5 trains a prosody model in the feature space divided by the feature space division unit 1 and generates a prosody generation model (Step S3B).

Next, the waveform training unit 11 trains a waveform model in the feature space divided by the feature space division unit 1 and generates a waveform generation model (Step S4B).

Further, Step S2B, Step S3B and Step S4B may be performed in any order and be performed in parallel.

Next, the prosody generation model storage unit 6 stores the prosody generation model generated by the prosody training unit 5 and the sparse or dense information outputted from the sparse or dense state detection unit 2 (Step S5B).

Next, the waveform generation model storage unit 12 stores the waveform generation model generated by the waveform training unit 11 and the sparse or dense information outputted by the sparse or dense state detection unit 2 (Step S6B).

Further, Step S5B and Step S6B may be performed in reverse order and it may be performed in parallel.

FIG. 10 is a flowchart which shows an operation example of the speech synthesis step that performs the speech synthesis processing actually in the speech synthesis system 3000.

As shown in FIG. 10, first, when a text which is an object of speech synthesis is inputted, the pronunciation information generation unit 8 generates pronunciation information using the pronunciation information generation dictionary 7 (Step S7B).

Next, the pronunciation information correcting unit 13 corrects the pronunciation information based on the sparse or dense information of each cluster which the prosody generation model storage unit 6 stores (Step S8B).

Next, the prosody generation unit 9 generates prosody information using the prosody generation model which the prosody generation model storage unit 6 stores to the pronunciation information corrected by the pronunciation information correcting unit 3 (Step S9B).

Next, the waveform generating unit 10 generates the speech waveform using the waveform generation model which the waveform generation model storage unit 12 stores, based on the pronunciation information and the prosody information which the prosody generation unit 9 has generated (Step S10B).

According to this exemplary embodiment as mentioned above, because the pronunciation information correcting unit 13 corrects the additional information, the feature such as the habits for each speaker can be reproduced faithfully. According to this exemplary embodiment, by using the same clustering result for extracting the sparse or dense information used for the correction of the pronunciation information and waveform training, the problem that the sound quality of the part gets degraded can be avoided when the waveform is generated with the waveform generation model belonging to the sparse cluster.

Further, in a waveform connection method or the like which does not use the HMM for the waveform generation, data volume of the corresponding unit waveform is also lacking in the data whose training data belongs to a sparse cluster. Therefore, according to this exemplary embodiment, when the waveform connection method or the like is used, the effect can be obtained that the sound quality degradation can be avoided by the point that the data belonging to the sparse cluster is not used.

Although the present invention has been described with reference to each exemplary embodiment above, the present invention is not limited to the exemplary embodiment mentioned above. Various modifications which a person with an ordinary skill in the art can understand in the scope of the present invention can be performed in the composition of the present invention and details. For example, the speech synthesis system according to each exemplary embodiment may use appropriately the correspondence table or the like which is referred to, after storing the extracted sparse or dense information in the database which is not shown.

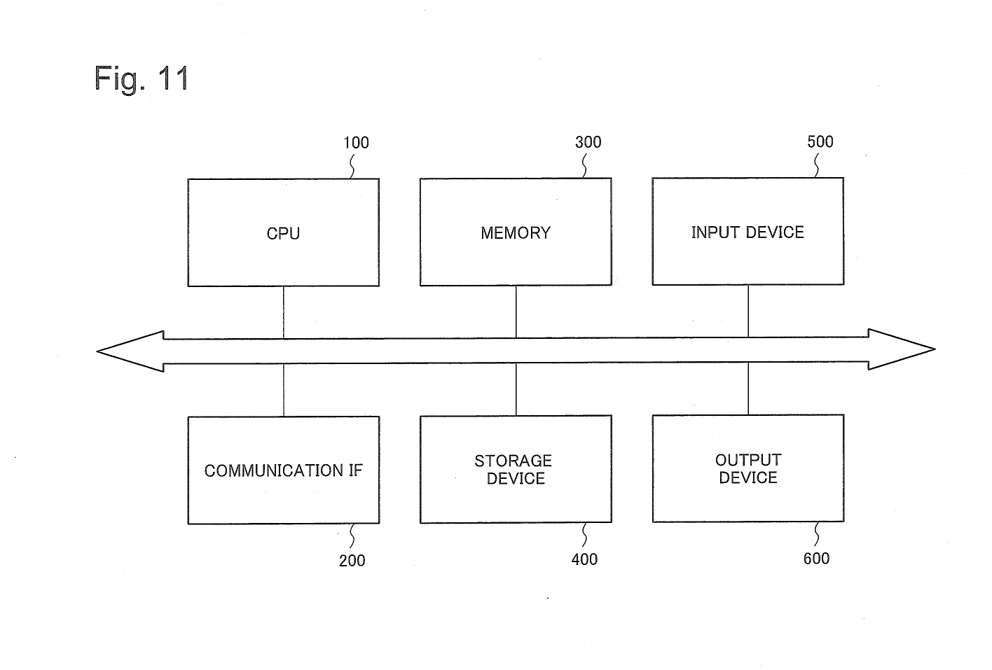

FIG. 11 is a block diagram which shows an example of a hardware configuration which realizes the speech synthesis system 2000 according to the second exemplary embodiment. Further, although the second exemplary embodiment is described as an example here, the speech synthesis system according to the other embodiment may also be realized by a similar hardware configuration.

As shown in FIG. 11, each part of which the speech synthesis system 2000 is composed is realized by a computer system including a CPU (Central Processing Unit) 100, a communication IF 200 (interface 200) for the network connecting, a memory 300, a storage device 400 such as a hard disk which stores a program, a input device 500 and an output device 600. However, the composition of the speech synthesis system 2000 is not limited to the computer system shown in FIG. 11.

The CPU 100 operates an operating system and controls the whole of the speech synthesis system 2000. The CPU 100 reads a program and the data from a recording medium loaded on a drive apparatus, for example, for the memory 300 and carries out the various processing according to this.

The storage device 400 is an optical disc, for example, a flexible disc, a magnetic optical disc, an external hard disk and a semiconductor memory or the like, and records a computer program which is readable with a computer. For example, the storage device 400 may be the training database 4 or the prosody generation model storage unit 6. The computer program may be downloaded from an external computer (not shown) which is connected to a communication network.

The input device 500, for example, receives an input text from the user in the speech training device 40. The output device 600 outputs generated synthetic speech finally.

Further, the block diagram described so far which is used in each embodiment indicates not the composition of the hardware unit but a block of the function unit. Further, the realization means of the speech synthesis system 2000 is not limited in particular. That is, the speech synthesis system 2000 may be realized by one apparatus which is combined physically or may be realized by a plurality of these apparatus in which two or more apparatus are connected with a wire or wireless means. In the case, the two apparatus separated physically may be made of the speech synthesis training device 20 and the speech synthesizer 40 respectively.

A program of the present invention will be a program which makes a computer execute each operation described in each embodiment mentioned above.

In each embodiment mentioned above, the characteristic composition of the speech synthesizer, the speech synthesis method and the speech synthesis program is indicated as shown in below.

[Supplementary Note 1]

A speech synthesis system comprising:

a training database storing training data which is set of features extracted from speech waveform data;

a feature space division means for dividing a feature space which is a space concerning to the training data which said training database stores into partial spaces;

a sparse or dense state detection means for detecting a sparse or dense state to each partial space which is the feature space divided by said feature space division means, generating sparse or dense information which is information indicating the sparse or dense state and outputting the sparse or dense information; and

a pronunciation information correcting means for correcting pronunciation information which is used for speech synthesis based on the sparse or dense information outputted from said sparse or dense state detection means.

[Supplementary Note 2]

The speech synthesis system according to supplementary note 1, further comprising:

a prosody training means for training a prosody model in the partial space which is the feature space divided by said feature space division means and generating a prosody generation model;

a prosody generation model storage means for storing the prosody generation model generated by said prosody training means and the sparse or dense information outputted from said sparse or dense state detection means; and

a prosody generation means for generating prosody information using the prosody generation model which said prosody generation model storage means stores to the pronunciation information corrected by said pronunciation information correcting means.

[Supplementary Note 3]

The speech synthesis system according to supplementary note 1 or 2, further comprising:

a pronunciation information generation dictionary which stores score for generation of the pronunciation information; and

a pronunciation information generation means for generating a plurality of candidates of pronunciation information using the score that said pronunciation information generation dictionary stores and outputting the candidates of the pronunciation information up to the N-th rank in higher score order for inputted text;

wherein said pronunciation information correcting means selects a candidate of the pronunciation information including only an accent phrase belonging to a dense partial space from the candidates of the pronunciation information which said pronunciation information generation means has generated based on said sparse or dense information.

[Supplementary Note 4]

The speech synthesis system according to supplementary note 1 or 2, further comprising:

a pronunciation information generation dictionary which stores score for generation of the pronunciation information; and

a pronunciation information generation means for generating pronunciation information using the score that said pronunciation information generation dictionary stores and outputting the pronunciation information;

when the pronunciation information which said pronunciation information generation means has generated includes an accent phrase belonging to a sparse cluster, said pronunciation information correcting means corrects the pronunciation information by substituting the accent phrase with an accent phrase belonging to a dense cluster with reference to said pronunciation information generation dictionary based on said sparse or dense information.

[Supplementary Note 5]

The speech synthesis system according to supplementary note 1 or 2, further comprising:

a pronunciation information generation dictionary which stores score for generation of the pronunciation information; and

a pronunciation information generation means for generating a piece of pronunciation information using the score that said pronunciation information generation dictionary stores, generating candidates for each accent phrase boundary of the pronunciation information up to the N-th rank and outputting the candidates;

when the pronunciation information which said pronunciation information generation means has generated includes an accent phrase belonging to a sparse cluster, said pronunciation information correcting means corrects the pronunciation information by a route search method using a score calculation whose unit is the accent phrase based on said sparse or dense information.

[Supplementary Note 6]

The speech synthesis system according to any one of supplementary notes 1-5, wherein said pronunciation information correcting means corrects a pause insertion position, expression of an input text or the like concerning to said pronunciation information.

[Supplementary Note 7]

The speech synthesis system according to any one of supplementary notes 1-6, wherein said feature space division means divides the feature space into the partial spaces by binary tree clustering based on the amount of information.

[Supplementary Note 8]

The speech synthesis system according to any one of supplementary notes 2-7, wherein said prosody training means trains said prosody model by HMM training.

[Supplementary Note 9]

The speech synthesis system according to any one of supplementary notes 1-8, further comprising:

a waveform training means for training a waveform model in the partial space which is the feature space divided by said feature space division means and generating a waveform generation model;

a waveform generation model storage means for storing the waveform generation model generated by said waveform training means; and

a waveform generation means for generating speech waveform using the waveform generation model which said waveform generation model storage means stores from the prosody information which said prosody generation means has generated and outputting the generated speech waveform as synthetic speech.

[Supplementary Note 10]

A speech synthesis method comprising:

storing training data which is set of features extracted from speech waveform data;

dividing a feature space which is a space concerning to said stored training data into partial spaces;

detecting a sparse or dense state to each partial space which is said divided feature space, generating sparse or dense information which is information indicating the sparse or dense state, and outputting the sparse or dense information; and

correcting pronunciation information which is used for speech synthesis based on said outputted sparse or dense information.

[Supplementary Note 11]

A recording medium for storing a program which makes a computer execute processing for

storing training data which is set of features extracted from speech waveform data;

dividing a feature space which is a space concerning to said stored training data into partial spaces;

detecting a sparse or dense state to each partial space which is said divided feature space, generating sparse or dense information which is information indicating the sparse or dense state, and outputting the sparse or dense information; and

correcting pronunciation information which is used for speech synthesis based on said outputted sparse or dense information.

Although the present invention has been described with reference to exemplary embodiments, the present invention is not limited to these exemplary embodiments mentioned above. The various modifications which a skilled person can understand in the scope of the present invention can be applied in the composition of the present invention and the details.

This application is based upon and claims the benefit of priority from Japanese Patent Application No. 2011-035542, filed on Feb. 22, 2011, the disclosure of which is incorporated herein in its entirety by reference.

### THE INDUSTRIAL APPLICABILITY

As it has been described above, the present invention is suitably applicable when a speech synthesis system using training data whose amount of information is limited is built. For example, it is applied to a reading system for text in general such as the news articles and the automatic answering sentences.

### EXPLANATION OF REFERENCE SIGNS

1 Feature space division unit

2 Sparse or dense state detection unit

3, 13 Pronunciation information correcting unit

4 Training database

5 Prosody training unit

6 Prosody generation model storage unit

7 Pronunciation information generation dictionary

8 Pronunciation information generation unit

9 Prosody generation unit

10, 14 Waveform generating unit

11 Waveform training unit

12 Waveform generation model storage unit

20, 21 Speech synthesis training device

30, 31 HMM training unit

40, 41 Speech synthesizer

100 CPU

200 Communication IF

300 Memory

400 Storage device

500 Input device

600 Output device

1000, 2000, 3000 Speech synthesis system

1. A speech synthesis system comprising:
a training database storing training data which comprises a set of features extracted from speech waveform data;
a feature space division unit which divides a feature space which comprises a space concerning to the training data which said training database stores into partial spaces;
a sparse or dense state detection unit which detects a sparse or dense state to each partial space which comprises the feature space divided by said feature space division unit, generates sparse or dense information which comprises information indicating the sparse or dense state and outputs the sparse or dense information; and
a pronunciation information correcting unit which corrects pronunciation information which is used for speech synthesis based on the sparse or dense information outputted from said sparse or dense state detection unit.

2. The speech synthesis system according to claim 1, further comprising:
a prosody training unit which trains a prosody model in the partial space which comprises the feature space divided by said feature space division unit and generates a prosody generation model;
a prosody generation model storage unit which stores the prosody generation model generated by said prosody training unit and the sparse or dense information outputted from said sparse or dense state detection unit; and
a prosody generation unit which generates prosody information using the prosody generation model which said prosody generation model storage unit stores to the pronunciation information corrected by said pronunciation information correcting unit.

3. The speech synthesis system according to claim 1, further comprising:
a pronunciation information generation dictionary which stores score for generation of the pronunciation information; and
a pronunciation information generation unit which generates a plurality of candidates of pronunciation information using the score that said pronunciation information generation dictionary stores and outputs the candidates of the pronunciation information up to the N-th rank in higher score order for inputted text;
wherein said pronunciation information correcting unit selects a candidate of the pronunciation information including only an accent phrase belonging to a dense partial space from the candidates of the pronunciation information which said pronunciation information generation unit has generated based on said sparse or dense information.

4. The speech synthesis system according to claim 1, further comprising:
a pronunciation information generation dictionary which stores score for generation of the pronunciation information; and
a pronunciation information generation unit which generates pronunciation information using the score that said pronunciation information generation dictionary stores and outputs the pronunciation information;
when the pronunciation information which said pronunciation information generation unit has generated includes an accent phrase belonging to a sparse cluster, said pronunciation information correcting unit corrects the pronunciation information by substituting the accent phrase with an accent phrase belonging to a dense cluster with reference to said pronunciation information generation dictionary based on said sparse or dense information.

5. The speech synthesis system according to claim 1, further comprising:
a pronunciation information generation dictionary which stores score for generation of the pronunciation information; and
a pronunciation information generation unit which generates a piece of pronunciation information using the score that said pronunciation information generation dictionary stores, generates candidates for each accent phrase boundary of the pronunciation information up to the N-th rank and outputs the candidates;
when the pronunciation information which said pronunciation information generation unit has generated includes an accent phrase belonging to a sparse cluster, said pronunciation information correcting unit corrects the pronunciation information by a route search method using a score calculation whose unit is the accent phrase based on said sparse or dense information.

6. The speech synthesis system according to claim 1, wherein said pronunciation information correcting unit corrects a pause insertion position or expression of an input text concerning to said pronunciation information.

7. The speech synthesis system according to claim 2, wherein said feature space division unit divides the feature space into the partial spaces by binary tree clustering based on the amount of information.

8. The speech synthesis system according to claim 2, wherein said prosody training unit trains said prosody model by HMM training.

9. A speech synthesis method comprising:
storing training data which comprises a set of features extracted from speech waveform data;
dividing a feature space which comprises a space concerning to said stored training data into partial spaces;
detecting a sparse or dense state to each partial space which comprises said divided feature space, generating sparse or dense information which comprises information indicating the sparse or dense state, and outputting the sparse or dense information; and
correcting pronunciation information which is used for speech synthesis based on said outputted sparse or dense information.

10. A recording medium for storing a program which makes a computer execute processing for:
storing training data which comprises a set of features extracted from speech waveform data;
dividing a feature space which comprises a space concerning to said stored training data into partial spaces;
detecting a sparse or dense state to each partial space which comprises said divided feature space, generating sparse or dense information which comprises information indicating the sparse or dense state, and outputting the sparse or dense information; and
correcting pronunciation information which is used for speech synthesis based on said outputted sparse or dense information.
